(19) United States
(12) Patent Application Publication
(10) Pub. No.: US 2025/0217022 A1
(43) Pub. Date: Jul. 3, 2025

(54) FREEFORM CONTENT AREAS FOR COMPONENT CUSTOMIZATION IN A DESIGN INTERFACE

(71) Applicant: FIGMA, INC., San Francisco, CA (US)

(72) Inventors: Jacob Joseph Cameron MILLER, Seattle, WA (US); Shana HU, San Francisco, CA (US)

(21) Appl. No.: 18/990,376

(22) Filed: Dec. 20, 2024

Related U.S. Application Data
(60) Provisional application No. 63/617,360, filed on Jan. 3, 2024.

(51) Int. Cl. G06F 3/04845; G06F 3/0482; G06F 40/109; G06F 40/166

(52) U.S. Cl. CPC G06F 3/04845; G06F 3/0482; G06F 40/109; G06F 40/166

(57) ABSTRACT

A network computer provides interactive graphic design system instructions for execution at a user computing device. The user computing device determines that a main component in a design interface includes a freeform content area and rendering, on a canvas, a visual representation of the freeform content area within an instance of the main component. The user computing device further receives, via an input interface, a first set of user input specifying content to be inserted in the freeform content area of the instance and populates the freeform content area within the instance with the content.

### CROSS-REFERENCE TO RELATED APPLICATIONS

This application claims priority benefit of United States Provisional Patent Application titled “FREEFORM CONTENT AREAS FOR COMPONENT CUSTOMIZATION IN A DESIGN INTERFACE,” Ser. No. 63/617,360, filed Jan. 3, 2024. The subject matter of this related application is hereby incorporated herein by reference.

### TECHNICAL FIELD

Examples described herein relate to a network computer system, and relate more specifically to freeform content areas for component customization in interactive graphic design systems.

### BACKGROUND

Software design tools have many forms and applications. In the realm of application user interfaces, for example, software design tools require designers to blend functional aspects of a program with aesthetics and even legal requirements, resulting in a collection of pages that form the user interface of an application. For a given application, designers often have many objectives and requirements that are difficult to track.

### BRIEF DESCRIPTION OF THE DRAWINGS

FIG. 1A illustrates an interactive graphic design system for a computing device of a user, according to one or more examples.

FIG. 1B illustrates a network computing system to implement an interactive graphic design system on a user computing device, according to one or more examples.

FIG. 1C illustrates a network computing system to implement an interactive graphic design system for multiple users in a collaborative network platform, according to one or more examples.

FIGS. 2A-2E illustrate example user interfaces for customizing a component within a design interface, according to one or more examples.

FIG. 3 illustrates a process for customizing a component in a design interface, according to one or more examples.

FIG. 4 illustrates a process for generating a freeform content area within a main component in a design interface, according to one or more examples.

FIG. 5 illustrates a computer system on which one or more embodiments can be implemented.

FIG. 6 illustrates a user computing device for use with one or more examples, as described.

### DETAILED DESCRIPTION

Examples include a computer system that can operate to implement an interactive graphic design system that enables users to customize components in a design interface. In examples, a computer system is configured to implement an interactive graphic design system for users, such as user interface designers (“UI designers”), web designers, and web developers. In various examples, the computer system enables a user to create various types of content, such as interactive graphic designs, art, whiteboard content, program code, pseudocode, renderings, large or small language model prompts, multimedia content, presentations, websites, slide presentations, bulletins, and/or textual content.

Among other advantages, examples as described enable such users to customize components within the design interface via freeform content areas. A grouping of one or more elements within a main component can be converted into a freeform content area via one or more types of user input received over an input interface. When an instance of the main component is created, the freeform content area may be populated with editable versions of the element(s), and the input interface may include content suggestions for content to be inserted into the freeform content area. Additional user input received over the input interface may be used to add content that is related or unrelated to the content suggestions to the freeform content area.

Examples may be deployed in a collaborative environment, and may streamline the update and management of large design systems and improve the efficient functioning of computers in generating, updating, and customizing components within design interfaces. For example, a conventional design tool may allow users to generate a main component that includes a layout or collection of graphical elements within a hierarchy of layers. The conventional design tool may also allow users to create reusable “instances” of the main component within various designs. To facilitate the creation and management of consistent designs across projects, each instance may be linked to the main component and receive updates made to the main component. However, the hierarchy of layers may be fixed within the main component and all instances of the main component. Consequently, a designer may detach an instance from the main component to change this hierarchy within the instance. Once the instance is detached, updates to the main component are no longer propagated to the instance. Instead, the designer may be required to manually change the detached instance to reflect updates to the main component.

In contrast, the disclosed embodiments provide a freeform content area that allows layers to be added to, removed from, and/or modified within an instance of a main component in a “freeform” manner without detaching the instance from the main component, thereby allowing the instance to be customized and to continue receiving updates to the main component. To streamline configuration of the instance, content suggestions for content to be inserted into the freeform content area and/or size constraints on the dimensions of the content within the freeform content area may be displayed in conjunction with a visual representation of the freeform content area and/or instance. Consequently, the disclosed embodiments improve efficiency and resource overhead associated with configuring and customizing instances of main components, and with maintaining consistent designs across the main components and corresponding instances.

According to some examples, a computing device operates to receive interactive graphic design system instructions and workspace data describing one or more design interfaces. The computing device determines that a main component in a design interface includes a freeform content area. The computing device renders, on a canvas, a visual representation of the freeform content area within an instance of the main component. The computing device displays one or more content suggestions for content to be inserted in the freeform content area. The computing device receives, via an input interface, a first set of user input specifying the content to be inserted in the freeform content area of the instance. The computing device generates the instance having the content within the freeform content area.

Still further, in some examples, a network computer system includes memory resources storing a set of instructions, and one or more processors operable to communicate the set of instructions to a plurality of user devices. The set of instructions can be communicated to user computing devices and executed at the user computing devices to render a design interface on a canvas. The design interface can be edited by user input that is indicative of any one of multiple different input actions. The set of instructions can be executed on the computing devices to cause each of the computing devices to determine one or more input actions to perform based on user input. The instructions may further cause the user computing devices to modify the design interface, create components within the design interface, create instances of the components, and/or generate other output based on one or more input actions.

In some examples, for at least a first computing device, the instructions can be executed to cause the computing device to determine that a main component in a design interface includes a freeform content area. The computing device renders, on a canvas, a visual representation of the freeform content area within an instance of the main component. The computing device displays one or more content suggestions for content to be inserted in the freeform content area. The computing device receives, via an input interface, a first set of user input specifying the content to be inserted in the freeform content area of the instance. The computing device generates the instance having the content within the freeform content area.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a non-transitory computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices and/or tablets), and magnetic memory. Computers, terminals, network-enabled devices (e.g., mobile devices, such as cell phones) are all examples of machines and devices that utilize processors, memory, and instructions stored on computer-readable mediums. Additionally, embodiments may be implemented in the form of computer-programs, or a computer-usable carrier medium capable of carrying such a program.

### System Description

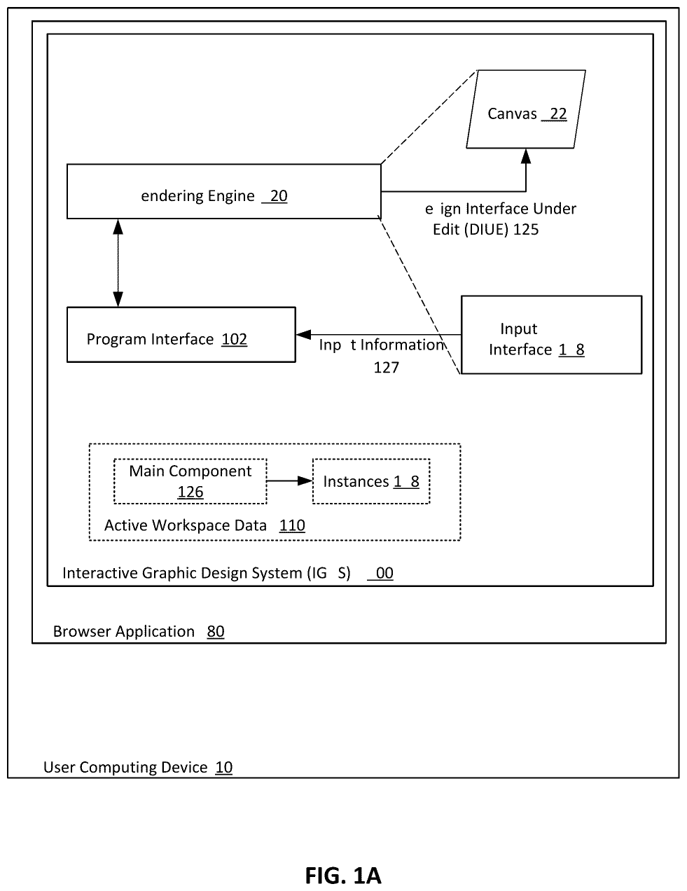

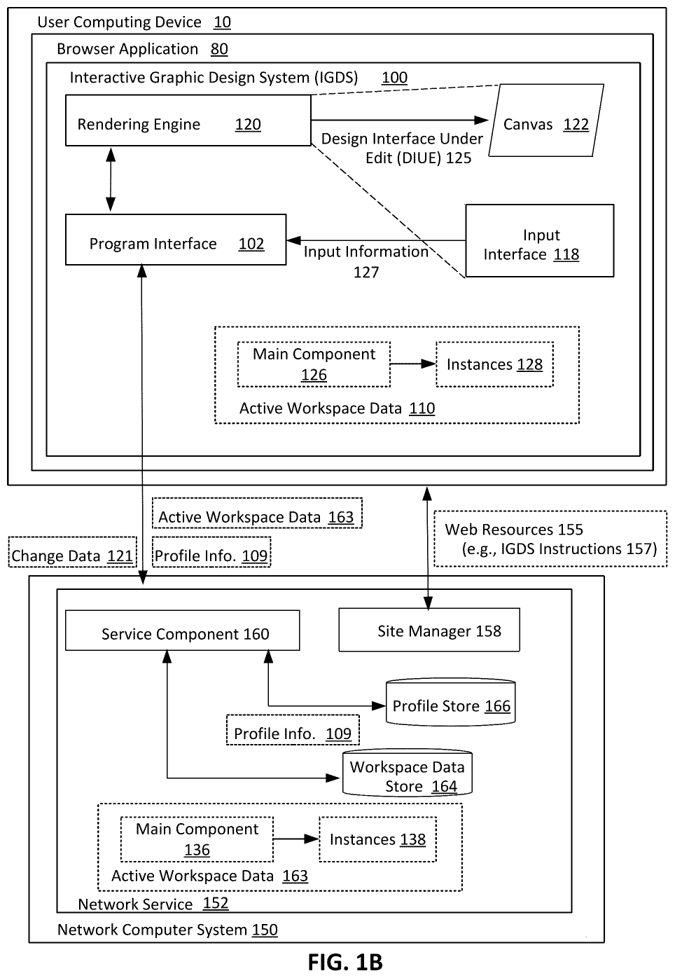

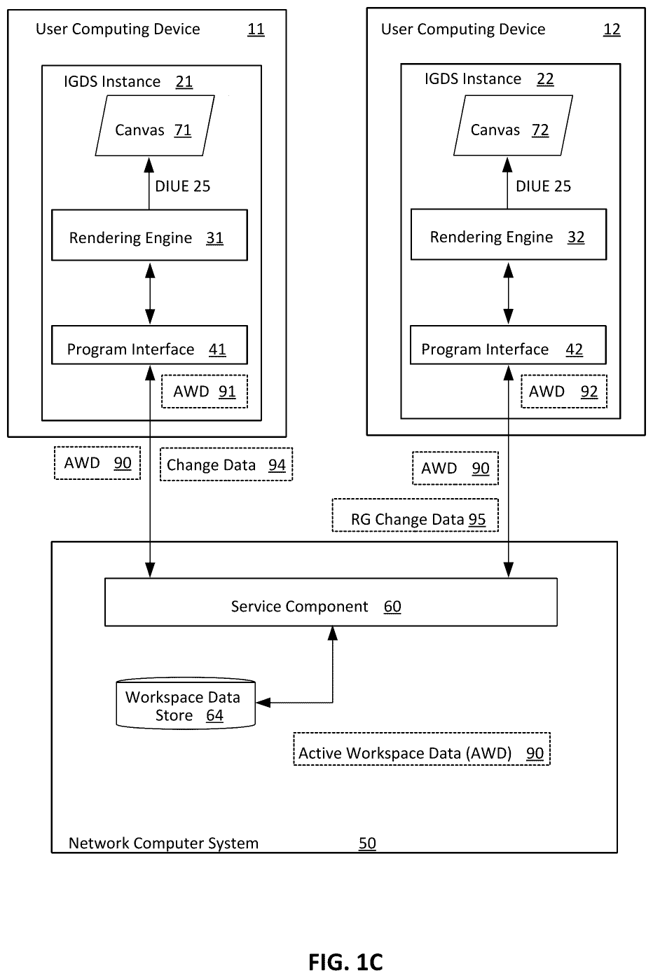

FIG. 1A illustrates an interactive graphic design system (IGDS) 100 for a computing device of a user, according to one or more examples. The IGDS 100 can be implemented in any one of multiple different computing environments. For example, in some variations, the IGDS 100 can be implemented as a user-side application that executes on the user computing device 10 to provide functionality as described with various examples. In another example, as described below, the IGDS 100 can be implemented as a web application that executes in a browser application 80. As an addition or alternative, the IGDS 100 may be implemented as a native application developed for use on a particular platform, such as but not limited to LINUX, ANDROID, WINDOWS, or another platform. As an addition or alternative, the IGDS 100 can be implemented as a distributed system, such that processes described with various examples execute on a network computer (e.g., server) and on the user device 10.

According to examples, the IGDS 100 can be implemented on a user computing device 10 to enable a corresponding user to create, view, and/or modify various types of design interfaces using graphical elements. A design interface may include any layout of content and/or interactive elements, such as (but not limited to) a web page. The IGDS 100 can include processes that execute as or through a browser application 80 that is installed on the computing device 10.

As used herein, the term “browser application” refers to any program that accesses web content over a network, such as by using the Hypertext Transfer Protocol (HTTP) to access information resources over the Internet. In some examples, the browser application 80 is a commercially available browser application, such as but not limited to GOOGLE CHROME (developed by GOOGLE, INC.), SAFARI (developed by APPLE, INC.), and EDGE/INTERNET EXPLORER (developed by the MICROSOFT CORPORATION). As described by various examples, a browser application 80 can execute scripts, code, and/or other logic (the “programmatic components”) to implement the functionality of the IGDS 100. Additionally, in some variations, the IGDS 100 can be implemented as part of a network service, where the browser application 80 communicates with one or more remote computers (e.g., server used for a network service) to execute processes of the IGDS 100.

The browser application 80 can retrieve some or all of the programmatic resources for implementing the IGDS 100 from a network site. As an addition or alternative, the browser application 80 can retrieve some or all of the programmatic resources from a local source (e.g., local memory residing with the computing device 10). The browser application 80 may also access various types of data sets in providing the IGDS 100. The data sets can correspond to files and/or libraries, which can be stored remotely (e.g., on a server, in association with an account, etc.) or locally.

The IGDS 100 can be implemented as web code that executes in a browser application 80. This web code can include (but is not limited to) HyperText Markup Language (HTML), JAVASCRIPT, Cascading Style Sheets (CSS), other scripts, and/or other embedded code which the browser application 80 downloads from a network site. For example, the browser application 80 can execute web code that is embedded within a web page, causing the IGDS 100 to execute at the user computer device 10 in the browser application 80. The web code can also cause the browser application 80 to execute and/or retrieve other scripts and programmatic resources (e.g., libraries) from the network site and/or other local or remote locations. By way of example, the browser application 80 may include JAVASCRIPT embedded in an HTML resource (e.g., web page structured in accordance with HTML 5.0 or other versions, as provided under standards published by W3C or WHATWG consortiums) that is executed by the browser application 80. In some examples, the rendering engine 120 and/or other components may utilize graphics processing unit (GPU) accelerated logic, such as provided through WebGL (Web Graphics Library) programs which execute Graphics Library Shader Language (GLSL) programs that execute on GPUs.

A user of the computing device 10 can operate the browser application 80 to access a network site, where programmatic resources are retrieved and executed to implement the IGDS 100. In this way, the user may initiate a session to implement the IGDS 100 to create, view, and/or modify a design interface. In some embodiments, the IGDS 100 includes a program interface 102, an input interface 118, and a rendering engine 120. The program interface 102 can include one or more processes that execute to access and retrieve programmatic resources from local and/or remote sources.

In some implementations, the program interface 102 can generate a canvas 122 using programmatic resources that are associated with the browser application 80 (e.g., an HTML 5.0 canvas). As an addition or variation, the program interface 102 can trigger or otherwise cause the canvas 122 to be generated using programmatic resources and data sets (e.g., canvas parameters) which are retrieved from local (e.g., memory) or remote sources (e.g., from network service).

The program interface 102 may also retrieve programmatic resources that include an application framework for use with the canvas 122. The application framework can include data sets that define or configure a set of interactive graphic tools that integrate with the canvas 122. For example, the interactive graphic tools may include an input interface 118 to enable the user to provide input for creating and/or editing a design interface.

According to some examples, the input interface 118 can be implemented as a functional layer that is integrated with the canvas 122 to detect and interpret user input, such as the input interface 118. In one or more embodiments, the input interface 118 includes a user interface that can, for example, use a reference of the canvas 122 to identify a screen location of a user input (e.g., ‘click’). Additionally, the input interface 118 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In this manner, the input interface 118 can interpret, for example, a series of inputs as a design tool selection (e.g., shape selection based on location/s of input), as well as inputs to define properties (e.g., dimensions) of a selected shape.

Additionally, the program interface 102 can be used to retrieve, from local or remote sources, programmatic resources and data sets that include active workspace data 110. As used herein, the term “workspace data” refers to data describing a design interface that can be loaded by the IGDS 100, the term “design interface under edit” refers to a design interface that is loaded in the IGDS 100, and the term “active workspace data” refers to workspace data describing a design interface under edit (DIUE) that is loaded in the IGDS 100.

The retrieved data sets can include one or more pages that include design elements that collectively form a design interface, or a design interface that is in progress. For example, the program interface 102 may be used to retrieve one or more files storing active workspace data 110. This active workspace data 110 can additionally include one or multiple data structure representations that collectively define the DIUE 125. For example, active workspace data 110 may include a main component 126 that defines properties of one or more design elements. Active workspace data 110 may also include one or more instances 128 of main component 126. Each instance is a copy of at least some portion of main component 126 that can be reused in design interfaces. Instances 128 are linked to main component 126 such that updates made to the main component 126 are propagated to the linked instances 128. In various examples, an update to the main component updates the non-freeform content areas of the linked instances of the main component. In such a manner, content or design elements in the non-freeform content area of a linked instance of the main component remain unperturbed responsive to the update. In various examples, instances 128 linked to the main component 126 can be managed in a unified manner using the main component 126. Further, code and memory associated with an instance 128 can be optimized or executed in an efficient manner due to the link between the main component 126 and the instance 128.

The IGDS 100 may also load and/or request additional data sets that are associated with the active workspace. As an example, the program interface 102 can retrieve, from local memory or another source (e.g., network service 152 of FIG. 1B), one or more types of profile information (e.g., profile information 109 of FIG. 1B), such as user profile information that identifies past activities of the user of the computing device 10 when utilizing the IGDS 100. The profile information can identify, for example, input types (or actions) of the user with respect to the page(s) of the active workspace, or more generally, input actions of the user in a prior time interval. In some variations, the profile information can also identify historical or contextual information about individual design interfaces associated with the profile.

The rendering engine 120 renders the DIUE 125 described by the active workspace data 110 on the canvas 122. For example, when a design interface is selected as the DIUE 125, the rendering engine 120 renders the design interface as described by the corresponding workspace data loaded as the active workspace data 110. The DIUE 125 includes graphic elements and their respective properties as described by the active workspace data 110. The user can edit the DIUE 125 using the input interface 118. As an addition or alternative, the rendering engine 120 can generate a blank page for the canvas 122, and the user can use the input interface 118 to generate the DIUE 125. As rendered, the DIUE 125 can include graphic elements such as a background and/or a set of objects (e.g., shapes, text, images, programmatic elements), as well as properties of the individual graphic elements. Each property of a graphic element can include a property type and a property value. For an object, the types of properties include shape, dimension (or size), layer, type, color, line thickness, font color, font family, font size, font style, and/or other visual characteristics. Depending on implementation details, the properties reflect attributes of two- or three-dimensional designs. In this way, property values of individual objects can define visual characteristics such as size, color, positioning, layering, and content for elements that are rendered as part of the DIUE 125. Workspace data, such as the active workspace data 110 corresponding to the DIUE 125, can describe one or more objects belonging to the design interface.

Individual design elements may also be defined in accordance with a desired run-time behavior. For example, some objects can be defined to have run-time behaviors that are either static or dynamic. The properties of dynamic objects may change in response to predefined run-time events generated by the underlying application that is to incorporate the DIUE 125. Additionally, some objects may be associated with logic that defines the object as being a trigger for rendering or changing other objects, such as through implementation of a sequence or workflow. Still further, other objects may be associated with logic that provides the design elements to be conditional as to when they are rendered and/or their respective configuration or appearance when rendered. Still further, objects may also be defined to be interactive, where one or more properties of the object may change based on user input during the run-time of the application.

The input interface 118 can process at least some user inputs to determine input information 127, where the input information 127 indicates (i) an input action type (e.g., shape selection, object selection, sizing input, color selection), (ii) an object or objects that are affected by the input action (e.g., an object being resized), (iii) a desired property that is to be altered by the input action, and/or (iv) a desired value for the property being altered. The program interface 102 can receive the input information 127, and the program interface 102 can implement changes indicated by the input information 127 to update the active workspace data 110. The rendering engine 120 can update the canvas 122 to reflect the changes to the affected objects in the DIUE 125. For example, when a given design interface is selected as the DIUE 125, the program interface 102 updates the corresponding active workspace data 110, and the rendering engine 120 updates the canvas 122 to reflect changes to the design interface indicated by the input information 127.

### Network Computing System to Implement IGDS

FIG. 1B illustrates a network computer system to implement the IGDS 100 on a user computing device, according to one or more examples. A network computer system 150 can be implemented using one or more servers that communicate with user computing devices over one or more networks. In some examples, the network computer system 150 performs operations to enable the IGDS 100 to be implemented on the user computing device 10.

In variations, the network computer system 150 provides a network service 152 to support the use of the IGDS 100 by one or more user computing devices, including a user computing device 10 that utilizes a browser application 80. The network computer system 150 can include a site manager 158 that manages a website where a set of web resources 155 (e.g., web pages, web code, and/or other web resources) are made available for site visitors. The web resources 155 can include instructions, such as scripts or other logic, which are executable by browsers or web components of user computing devices. In some variations, once the browser application 80 accesses and downloads the web resources 155, the browser application 80 executes the IGDS instructions 157 to implement functionality such as described with some examples of FIG. 1A. For example, the IGDS instructions 157 can be executed by browser application 80 to initiate the program interface 102 on the user computing device 10. The initiation of the program interface 102 may coincide with the establishment of, for example, a web-socket connection between the program interface 102 and a service component 160 of the network computer system 150.

In some examples, the IGDS instructions 157, when executed in the browser application 80, initiate one or more processes of the program interface 102, causing the IGDS 100 to retrieve additional programmatic resources and data sets for implementing functionality as described herein by one or more examples. The web resources 155 can, for example, embed logic (e.g., JAVASCRIPT code), including GPU accelerated logic, in an HTML page for download by computing devices of users. The program interface 102 can be triggered to retrieve additional programmatic resources and data sets from, for example, the network service 152, and/or from local resources of the computing device 10. For example, some of the components of the IGDS 100 can be implemented through web pages that can be downloaded onto the user computing device 10 after authentication is performed, and/or once the user performs additional actions (e.g., downloading one or more pages of the workspace associated with the account identifier). Accordingly, in one or more examples as described, the network computer system 150 can communicate the IGDS instructions 157 to the user computing device 10 through a combination of network communications, where the IGDS instructions 157 are received and executed by the browser application 80.

Upon accessing the website, the browser application 80 can automatically (e.g., through saved credentials) or through manual input, communicate an account identifier to the service component 160. In some examples, the browser application 80 can also communicate one or more additional identifiers that correlate to a user identifier. Additionally, in some examples, the service component 160 can use the user or account identifier of the user identifier to retrieve profile information 109 from a user profile store 166. As an addition or variation, profile information 109 for the user can be determined and stored locally on the user computing device 10. The service component 160 may also determine, based on the user credentials, a permission setting or role of the user in connection with the account identifier. The permission settings or role of the user can determine, for example, workspace data that can be accessed by the user. In some examples, the implementation of the rendering engine 120 on the user computing device 10 can be configured based at least in part on the role or setting of the user and/or affiliation of the user with a particular organization.

The service component 160 can also retrieve and provide workspace data describing a workspace that is linked to the user account or identifier from a workspace data store 164. For example, when a user selects a particular design interface to load in the IGDS 100, the program interface 102 may submit a request to the service component 160. The service component 160 may access the workspace data store 164 to retrieve the corresponding active workspace data 163 and provide the active workspace data 163 to the IGDS 100.

The active workspace data 163 for the selected design interface may include a main component 136 and/or one or more instances 138 of main component 136. When a user selects the design interface, the program interface 102 may submit a request to the service component 160, which retrieves the corresponding set of workspace data from the workspace data store 164 and provides the set of workspace data as active workspace data 163 to the IGDS 100. The IGDS 100 may maintain a user-side copy of the received active workspace data 163 (e.g., as active workspace data 110).

When a new design interface is created, the user computing device 10 may create a corresponding set of user-side active workspace data 110 and provide the set of user-side active workspace data 110 to the network computer system 150 so that the network computer system 150 can work with, store, update, and serve the active workspace data 110. As an alternative or addition, the program interface 102 may send a request to the service component 160 so that the service component 160 generates a corresponding set of active workspace data 163 at the network computer system 150. The service component 160 may provide the generated active workspace data 163 to the program interface 102 in response to the request. The IGDS 100 may maintain a user-side copy of the received active workspace data 163 (e.g., as active workspace data 110). The network computer system 150 may store the active workspace data 163 in the workspace data store 164 and make the active workspace data 163 available to other users.

In some examples, the IGDS 100 maintains user-side active workspace data 110 corresponding to the active workspace data 163 received from the network computer system 150. For example, the user-side active workspace data 110 may begin as a copy of the received active workspace data 163 that is stored in memory at the user computing device 10. In some examples, the IGDS 100 initiates the canvas 122 and renders the corresponding design interface under edit (DIUE) 125 to the canvas 122 based on the active workspace data 110. For example, the IGDS 100 can initiate an HTML 5.0 canvas as a component of the browser application 80, and the rendering engine 120 can render the corresponding DIUE 125 on the canvas 122.

In some examples, any changes to the DIUE 125 made using the IGDS 100 can also be updated in the user-side active workspace data 110, as stored on the computing device 10. In some embodiments, the program interface 102 sends change data 121 to the network computer system 150. The change data 121 reflects one or more changes to the DIUE 125 made in the IGDS 100 and to the user-side active workspace data 110. For example, the program interface 102 can stream change data 121 to the service component 160 periodically and/or in real-time as changes are made at the user computing device 10.

At the network computer system 150, the service component 160 can receive the change data 121, which in turn can be used to implement changes to the server-side active workspace data 163. In this way, the server-side active workspace data 163 at the network computer system 150 can mirror (or be synchronized with) the user-side active workspace data 110 on the user computing device 10. For example, the program interface 102 can stream the changes as change data 121 to the service component 160 to synchronize the user-side active workspace data 110 and the server-side active workspace data 163 corresponding to the DIUE 125. This process can be performed repeatedly or continuously so that the user-side active workspace data 110 and the server-side active workspace data 163 describing the DIUE 125 remain synchronized.

### Collaborative Network Platform

FIG. 1C illustrates a network computer system to implement an interactive graphic design system for multiple users in a collaborative network platform, according to one or more examples. In an example of FIG. 1C, a collaborative network platform is implemented by the network computer system 50, which communicates with multiple user computing devices 11-12 over one or more networks (e.g., the World Wide Web) to implement interactive graphic design system (IGDS) instances 21-22 on the user computing devices 11-12. While FIG. 1C illustrates an example in which two users utilize the collaborative network platform, examples as described allow for the network computer system 50 to enable collaboration on design interfaces among users using a larger number of user computing devices. Among other advantages, the collaborative network platform allows users to more concurrently access a design interface, and to conveniently manipulate objects based on a shared property value while the network computer system 50 manages synchronization and access issues.

With respect to FIG. 1C, the user computing devices 11-12 can be assumed as being operated by users that are associated with a common account or accounts associated with the same design interface. Each user computing device 11-12 implements an IGDS instance 21-22 to access the same design interface (e.g., DIUE 25) during respective sessions that overlap with one another. Accordingly, each of the user computing devices 11-12 may access the same set of active workspace data 90 at the same time, with the respective program interface 41-42 of the IGDS instance 21-22 operating to establish a corresponding communication channel (e.g., a web socket connection) with the service component 60. In examples, the service component 60 can load the active workspace data 90 corresponding to the DIUE 25 from a workspace data store 64, and transmit a copy of the active workspace data 90 to each user computing device 11-12 such that the respective rendering engines 31-32 render the DIUE 25 corresponding to the active workspace data 90 at the same time, such as during overlapping sessions.

In some examples, after receiving the active workspace data 90, the IDGS instance 21 maintains user-side active workspace data 91 at user computing device 11, and the IDGS instance 22 maintains user-side active workspace data 92 at user computing device 12. The service component 60 can also maintain network-side active workspace data 90 for the DIUE 25 loaded by the IGDS instances 21-22.

In some examples, the network computer system 50 can continuously synchronize the active workspace data 90-92 corresponding to the DIUE 25 loaded in one or more IGDS instances 21-22 on the user computing devices 11-12. Thus, changes made by users to the DIUE 25 on one user computing device 11 may be reflected on the DIUE 25 rendered on the other user computing device 12 in real-time. By way of example, when a change is made to the DIUE 25 at one user computing device 11, the respective rendering engine 31 updates the respective canvas 71, and the respective program interface 41 updates the respective user-side active workspace data 91. The respective program interface 41 of the IGDS instance 21 transmits change data 94 reflecting the DIUE 25 change to the service component 60. The service component 60 processes the change data 94 from the user computing device 11 and uses the change data 94 to make a corresponding change to the server-side active workspace data 90. The service component 60 can also transmit remotely-generated change data 95 (which in the example provided, corresponds or reflects the change data 94 received from the user computing device 11) to the other user computing device 12 that has loaded the same DIUE 25, causing the corresponding IGDS instance 22 to update the DIUE 25, such as by causing the program interface 42 to update the corresponding user-side active workspace data 92 and causing the respective rendering engine 32 to update the respective canvas 72. In this manner, active workspace data 91-92 is synchronized across any user computing devices 11-12 that are using the respective workspace data.

To facilitate the synchronization of the active workspace data 90-92 at the user computing devices 11-12 and the network computer system 50, the network computer system 50 may implement a stream connector to merge data streams between the network computer system 50 and user computing devices 11-12 that have loaded the same DIUE 25. For example, the stream connector may merge a first data stream between user computing device 11 and the network computer system 50 with a second data stream between user computing device 12 and the network computer system 50. In some implementations, the stream connector can be implemented to enable each computing device 11-12 to make changes to the server-side active workspace data 90 without added data replication that may otherwise be required to process the streams from each user computing device 11-12 separately.

Additionally, over time, one or more sets of user-side active workspace data 91-92 may become out-of-sync with the server-side active workspace data 90. In such cases, the respective computing device 11-12 can re-download some or all of the server-side active workspace data 90 to restart its maintenance of the corresponding user-side active workspace data 91-92 and DIUE 25 rendered on the respective canvas 71-72.

### Component Customization in a Design Interface

In some embodiments, the IGDS 100 includes functionality to enable customization of components within a design interface via freeform content areas. A freeform content area includes a region within a main component that allows users to insert, modify, move, and delete content in a “freeform” manner (e.g., without constraints or limitations on the organization of layers or elements within the main component). This feature allows an instance of the main component to remain linked to the main component, thereby ensuring that any updates to the main component are reflected in the instance and preserving consistency across different design projects while allowing for greater flexibility in changing the appearance, behavior, and/or other attributes of the instance. In various examples, an update to the main component updates the non-freeform content areas of the linked instances of the main component. In such a manner, content or design elements in the non-freeform content area of a linked instance of the main component remain unperturbed responsive to the update.

To create a freeform content area, a user may select a layer and/or another grouping of one or more elements within a main component and provide one or more user inputs to convert the selection into the freeform content area. The user input(s) may include (but are not limited to) a context menu selection (e.g., a right click), a keyboard shortcut, and/or a selection of a user-interface element. In response to the user input(s), the IGDS 100 creates the freeform content area within the main component and instances of the main component.

After the freeform content area is added to the main component, the IGDS 100 renders a visual representation of the freeform content area within instances of the main component on the canvas 122. A user can update the freeform content area via user inputs to the input interface 118, and the visual representation may be updated in real-time within the canvas 122 to reflect changes made by the user to the freeform content area.

When a freeform content area is created from one or more elements in the main component, the element(s) may be added to the freeform content area. These added elements may also be editable within instances of the main component. For example, users may add, rearrange, customize, or delete these elements within a given instance without detaching the instance from the main component.

To assist in the customization of the freeform content area, the IGDS 100 may generate content suggestions that are displayed in association with the freeform content area, elements added to the freeform content area, and/or portions of the freeform content area. These content suggestions may include predefined “preferred” elements for insertion into the freeform content area. The content suggestions may be organized or ranked based on criteria such as priority, usage, relevance, allow and/or block lists, and/or other criteria.

The IGDS 100 may also use size constraints to guide the insertion of content into the freeform content area. Users may define these size constraints to control the placement and/or dimensions of the inserted elements within the freeform content area. The size constraints may include fixed dimensions, scaling options, anchor points, and/or other spatial constraints that are specified with respect to the freeform content area.

### Examples—Component Customization Via Freeform Content Areas

The IGDS 100 is configured to render a user interface that allows a user to create a main component with one or more freeform content areas and customize the freeform content area(s) within individual instances of the main components. The user interface includes visual representations of the main component and instances. A visual representation may include a rendering of a design element and/or another portion of the design interface, a thumbnail rendering, an abstract representation (e.g., a color swatch, typeface), and/or another visual representation. One or more visual representations may be displayed “in context” within the canvas 122 for a given design interface.

The IGDS 100 may present the user interface based on and/or using various types of interaction between a user and the input interface 118. For example, the IGDS 100 may determine, based on user input received through the input interface 118, that a layer and/or another grouping of one or more components within a main component has been converted into (or is to be converted into) a freeform content area. In various embodiments, the grouping may be included or represented within a container. In response to this user input, the IGDS 100 may create the freeform content area within the main component and add editable versions of the component(s) to the freeform content area. When the user subsequently interacts with the IGDS 100 to view the main component, edit the main component, create an instance of the main component, and/or customize the instance of the main component, the IGDS 100 may display visual representations of the freeform content area within the main component and/or instance in the canvas 122. The user may provide additional input through input interface 118 to make adjustments or changes to the main component, instance, and/or corresponding freeform content areas. In response to this additional input, the IGDS 100 may update the corresponding visual representation(s) in the canvas 122 to reflect the changes in real-time.

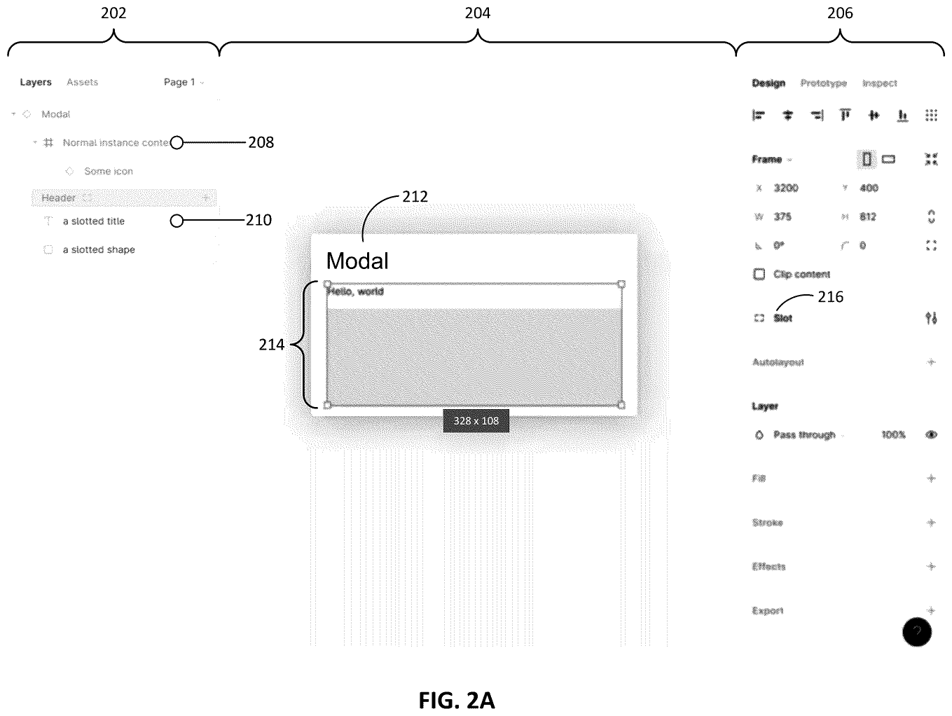

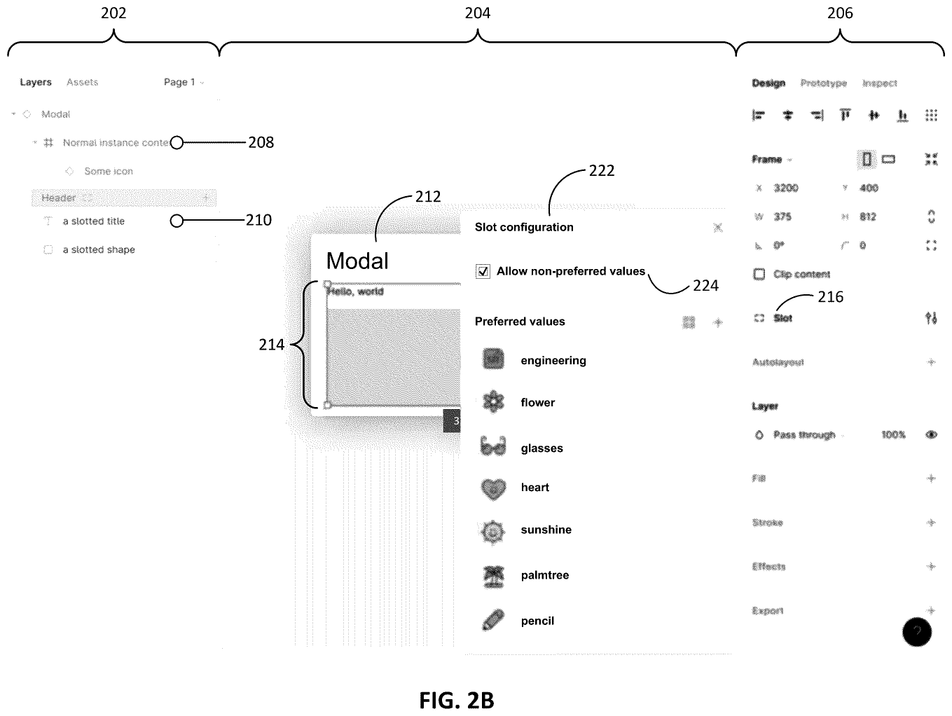

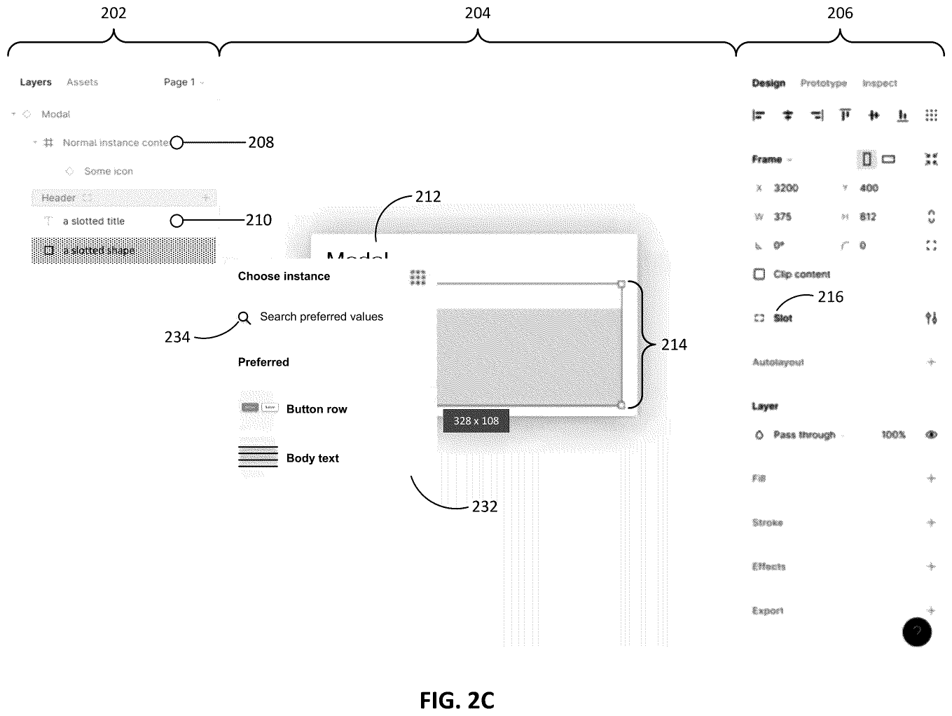

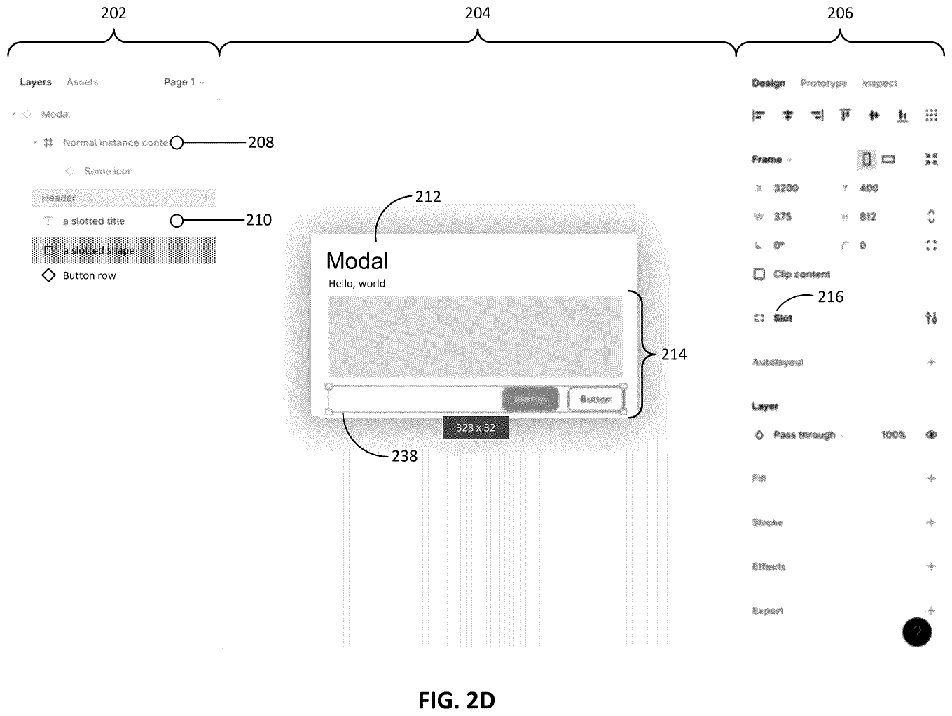

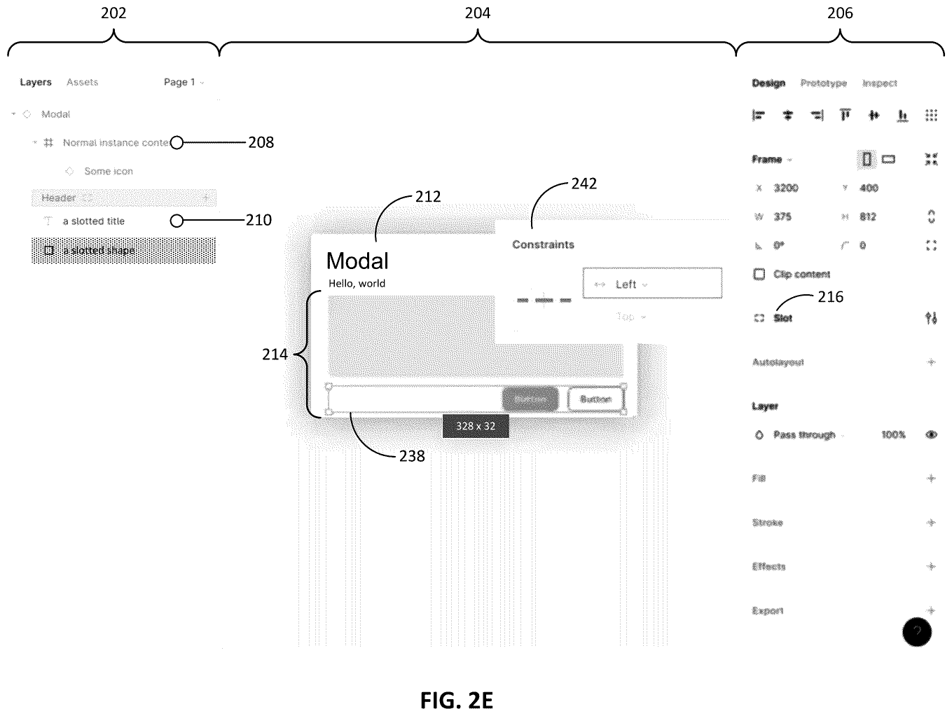

Example user interfaces are presented in FIGS. 2A-2E showing non-limiting example user interfaces for customizing a component within a design interface. FIG. 2A illustrates an example user interface for customizing an instance of a main component. The example user interface includes a canvas 204 within which a visual representation 212 of the instance is rendered. This visual representation 212 includes a freeform content area 214, which corresponds to a region of the main component into which various types of layers, elements, and/or content can be inserted.

The example user interface of FIG. 2A also includes a layers panel 202 associated with the instance. The layers panel 202 includes a hierarchy of components and layers within the instance. More specifically, the layers panel 202 includes a first portion 208 that is shown in a purple color. This coloration indicates that the corresponding layers cannot be deleted or rearranged without detaching the instance from the main component.

The layers panel 202 also includes a second portion 210 representing the freeform content area 214. This second portion 210 includes two layers named “a slotted title” and “a slotted shape.” The black coloration of these layers indicates that these layers can be deleted, moved, and/or otherwise modified.

The example user interface of FIG. 2A additionally includes a properties panel 206, which can be used to view and adjust the properties of all layers. The properties panel 206 includes a user-interface element 216 named “Slot,” which corresponds to the freeform content area 214. A user may interact with the user-interface element 216 to access additional user-interface elements related to customizing the freeform content area 214, as described in further detail below.

FIG. 2B illustrates the example user interface of FIG. 2A with a menu 222 of content suggestions for the freeform content area 214, according to one or more examples. A user may access the user interface of FIG. 2B by (for example) clicking on the user-interface element 216 within the properties panel 206, inputting a keyboard shortcut, clicking or right-clicking on the freeform content area 214 within the visual representation 212, and/or providing other types of user input.

As shown in FIG. 2B, the menu 222 includes a list of content suggestions for content to be inserted into the freeform content area 214. Each content suggestion includes one or more “preferred values” for content that can be added to the freeform content area 214. For example, each content suggestion may include preferred values for the type of element (e.g., shape, text, image, programmatic element, etc.) to be added, properties of the element (e.g., shape, dimension, layer, type, color, text, line thickness, font color, font family, font size, font style, etc.), a run-time behavior associated with the element, and/or other visual or behavioral attributes of the element.

Content suggestions may be included in and/or ranked within the menu 222 based on a variety of criteria. For example, one or more content suggestions may be added to the menu 222 by a creator or editor of the main component and/or a creator or editor of an instance of the main component. In another example, one or more content suggestions may be added to the menu 222, excluded from the menu, and/or ordered within the menu based on usage of each content suggestion within instances of the main component and/or in other contexts, user-specified scores or priorities associated with the content suggestion(s), user-specified lists of content that should be allowed in or excluded from the freeform content area 214, and/or the relevance of the content suggestions to the main component and/or freeform content area 214.

A user may interact with the menu 222 and/or other portions of the example user interface to add and/or customize content represented by one or more content suggestions in the menu 232 to the freeform content area 214. For example, the user may click on a content suggestion within the menu 222, provide a keyboard shortcut, and/or provide other types of user input to insert content represented by a given content suggestion into the freeform content area 214, customize the appearance and/or behavior of the inserted content, and/or perform other operations or customizations related to the freeform content area 214 and/or inserted content.

The menu 222 additionally includes a user-interface element 224 that is separate from the content suggestions. This user-interface element 224 includes a checkbox that can be selected to allow non-preferred values (e.g., content that is not listed within the menu 222) to be added to the freeform content area 214. Conversely, the checkbox can be unselected to prohibit non-preferred values from being added the freeform content area 214.

FIG. 2C illustrates the example user interface of FIG. 2A with a menu 232 of content suggestions for the layer named “a slotted shape” within the freeform content area 214. A user may access the user interface of FIG. 2C by (for example) clicking or right-clicking on the region corresponding to “a slotted shape” within the portion 210 representing the freeform content area 214 under the layers panel 202, inputting a keyboard shortcut, and/or providing other types of user input.

Unlike the example user interface of FIG. 2B, the menu 232 in the example user interface of FIG. 2C includes preferred values for content that can be added to the “a slotted shape” layer within the freeform content area 214. Thus, a user may access the menu 232 by (for example) clicking or right-clicking on a region corresponding to “a slotted title” layer within the layers panel 202 and/or another part of the user interface, inputting a keyboard shortcut, and/or providing other user input that is more directly related to the “a slotted shape” layer.

As shown in FIG. 2C, the menu 232 includes a list of content suggestions for content to be inserted into the “a slotted title” layer in freeform content area 214. Each content suggestion includes one or more “preferred values” for content that can be added to the layer. For example, the first content suggestion in the list may include preferred values for properties, runtime behavior, and/or other attributes associated with a row of buttons, and the second content suggestion in the list may include preferred values for properties, runtime behavior, and/or other attributes associated with a body of text.

A user may interact with the menu 232 and/or other portions of the example user interface to add and/or customize content represented by one or more content suggestions in the menu 232 to the freeform content area 214. For example, the user may click on a content suggestion within the menu 232, provide a keyboard shortcut, and/or provide other types of user input to insert content represented by a given content suggestion into the “a slotted title” layer, customize the appearance and/or behavior of the content, and/or perform other operations or customizations related to the “a slotted title” layer and/or content suggestion.

The menu 232 additionally includes a user-interface element 234 that is separate from the content suggestions. This user-interface element 234 includes a search feature that allows a user to input search terms and/or parameters related to the content suggestions. After the user submits a search via the user-interface element 234, the menu 232 may update to include a list of content suggestions that match the corresponding search term and/or parameters. The user may then select a content suggestion from the matching content suggestions to add the content suggestion to the layer.

FIG. 2D illustrates the example user interface of FIG. 2C after the “Button row” content suggestion has been selected from menu 232, according to one or more examples. As shown in FIG. 2D, the freeform content area 214 within the visual representation 212 of the instance has been updated to include a region 238 that includes a row of two buttons. The layers panel 202 has also been updated to include a “Button row” region within the portion 210 representing the freeform content area 214. The user may interact with the properties panel 206, the “Button row” region within the layers panel 202, context menus (not shown) associated with the region 238 and/or buttons, and/or other parts of the user interface to further customize the appearance and/or behavior of the buttons within the freeform content area 214.

FIG. 2E illustrates the example user interface of FIG. 2D with a user-interface element 242 for specifying size constraints associated with the region 238 that has been inserted into the freeform content area 214, according to one or more examples. For example, the user-interface element 242 may be shown after the user interacts with the user-interface element 216, clicks on the “Button row” region of the layers panel 202, provides a keyboard shortcut, and/or provides other user input related to the region 238.

As shown in FIG. 2E, the user-interface element 242 allows the user to specify size constraints related to the horizontal and vertical dimensions or scale of the region 238 within the freeform content area 214. Size constraints related to the horizontal dimension of the region 238 may include (but are not limited to) maintaining the position of the region 238 relative to the left and/or right sides of the freeform content area 214, maintaining the position of the region 238 relative to the horizontal center of the freeform content area 214, and/or scaling the size and position of the region 238 as a percentage of the horizontal dimension of the freeform content area 214. Size constraints related to the vertical dimension of the region 238 may include (but are not limited to) maintaining the position of the region 238 relative to the top and/or bottom of the freeform content area 214, maintaining the position of the region 238 relative to the vertical center of the freeform content area 214, and/or scaling the size and position of the region 238 as a percentage of the vertical dimension of the freeform content area 214.

Size constraints shown in the user-interface element 242 may include default or “preferred” values associated with the “Button row” content suggestion. These size constraints may be changed via interactions with the user-interface element 242 to customize the appearance of the region 238 within the freeform content area 214. These size constraints may also, or instead, be fixed, so that any content inserted by selecting the “Button row” content suggestion has the same “preferred” size constraints as those of the content suggestion.

While the example user interfaces of FIGS. 2A-2E depict freeform content area 214 within an instance of a main component that corresponds to a modal, it will be appreciated that other freeform content areas can be defined and customized within other types of components within a design interface. For example, one or more freeform content areas may be used to customize the content within a design interface for a mobile device (e.g., a mobile phone, tablet computer, portable game console, etc.). In another example, one or more freeform content areas may be used within a starter template for a website to allow for customization of navigation, headers, footers, and/or other elements of the website. In a third example, one or more freeform content areas may be used to customize the elements within a drop-down list and/or menu that is fixed within a main component and/or instances of the main component.

### Methodology

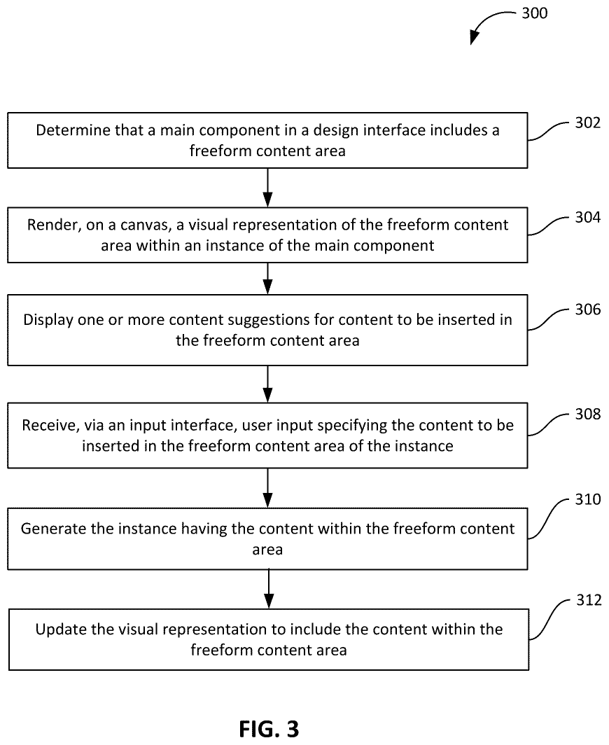

FIG. 3 illustrates a process 300 for customizing a component in a design interface, according to one or more examples. Process 300 may be performed by one or more computing devices and/or processes thereof. For example, one or more blocks of process 300 may be performed by a user computing device (e.g., user computing devices 10-12, 600). In some examples, one or more blocks of process 300 are performed by a user computing device executing IGDS instructions provided by a network computer system (e.g., network computer system 150, 50) and/or by the network computer system.

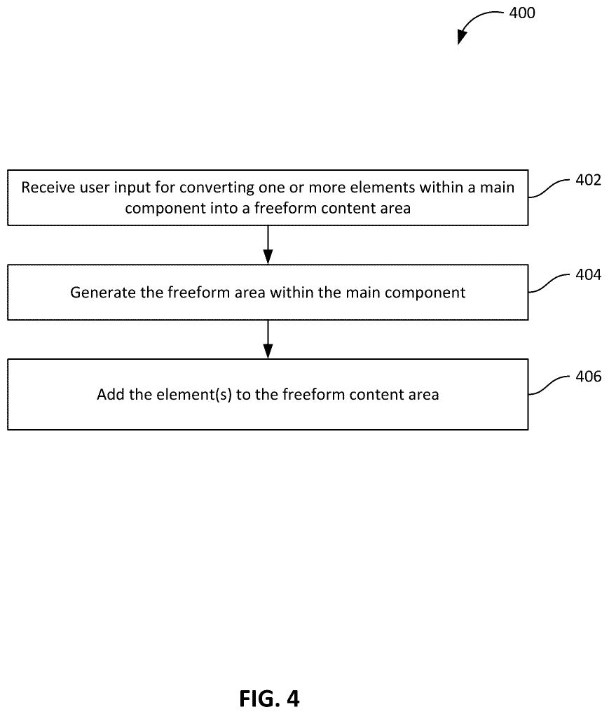

At block 302, a computing device, which may include (but is not limited to) the user computing device and/or network computer system, determines that a main component in a design interface includes a freeform content area. For example, the computing device may perform block 302 by creating the freeform content area within the main component in response to receiving user input for converting one or more elements within the main component into the freeform content area, as described in further detail below with respect to FIG. 4. In another example, the computing device may perform block 302 by determining that stored and/or loaded workspace data for the main component includes the freeform content area.

At block 304, the computing device renders, on a canvas, a visual representation of the freeform content area within an instance of the main component. For example, the computing device may render a visual representation of the instance within the canvas. The computing device may also render a visual representation of the freeform content area as a region within the visual representation of the instance.

At block 306, the computing device displays one or more content suggestions for content to be inserted in the freeform content area. For example, the computing device may provide the content suggestion(s) in one or more menus, lists, and/or user-interface elements. Each content suggestion may include preferred values associated with visual characteristics, behavior, and/or other attributes of one or more elements that can be added to the freeform content area.

At block 308, the computing device receives, via an input interface, user input specifying the content to be inserted in the freeform content area of the instance. For example, the user input may include a selection of a content suggestion displayed in block 306 and/or a selection of content that is separate from any content suggestions. The user input may also, or instead, specify parameters related to customizing the size, dimensions, behavior, appearance, and/or other attributes of the content.

At block 310, the computing device generates (e.g., populates) the instance having the content within the freeform content area. For example, the computing device may update workspace data for the instance to include or be populated with the content and/or customizations specified in the user input.

At block 312, the computing device updates the visual representation to include the content within the freeform content area. For example, the computing device may add the visual representation of the content to a region representing the freeform content area within the canvas.

FIG. 4 illustrates a process 400 for generating a freeform content area within a main component in a design interface, according to one or more examples. Process 400 may be performed by one or more computing devices and/or processes thereof. For example, one or more blocks of process 400 may be performed by a user computing device (e.g., user computing devices 10-12, 600). In some examples, one or more blocks of process 300 are performed by a user computing device executing IGDS instructions provided by a network computer system (e.g., network computer system 150, 50) and/or by the network computer system.

In block 402, a computing device, which may include (but is not limited to) the user computing device and/or network computer system, receives user input for converting one or more elements within a main component into a freeform content area. For example, the computing device may receive the user input as a selection within a context menu associated with the element(s) and/or a grouping of the element(s) (e.g., within a layer), a keyboard shortcut, and/or a selection of a user-interface element that can be used to generate the freeform content area.

In block 404, the computing device generates the freeform content area within the main component. For example, the computing device may add the freeform content area to workspace data for the main component.

In block 406, the computing device adds the element(s) to the freeform content area. For example, the computing device may add editable versions of the element(s) to the workspace area for the main component and associate the editable versions of the element(s) with the freeform content area.

### Network Computer System

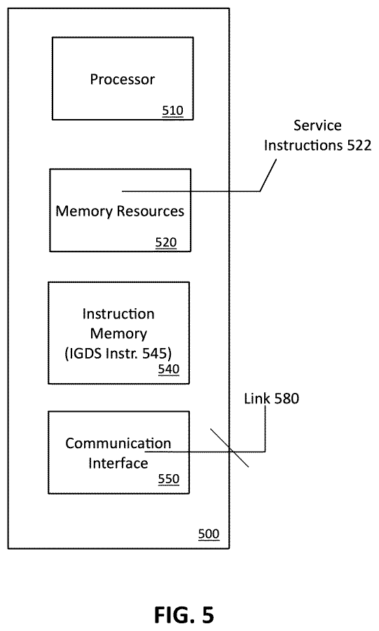

FIG. 5 illustrates a computer system on which one or more embodiments can be implemented. A computer system 500 can be implemented on, for example, a server or combination of servers. For example, the computer system 500 may be implemented as the network computer system 150 of FIG. 1A through FIG. 1C.

In one implementation, the computer system 500 includes processing resources 510, memory resources 520 (e.g., read-only memory (ROM) or random-access memory (RAM)), one or more instruction memory resources 540, and a communication interface 550. The computer system 500 includes at least one processor 510 for processing information stored with the memory resources 520, such as provided by a random-access memory (RAM) or other dynamic storage device, for storing information and instructions which are executable by the processor 510. The memory resources 520 may also be used to store temporary variables or other intermediate information during execution of instructions to be executed by the processor 510.

The communication interface 550 enables the computer system 500 to communicate with one or more user computing devices, over one or more networks (e.g., cellular network) through use of the network link 580 (wireless or a wire). Using the network link 580, the computer system 500 can communicate with one or more computing devices, specialized devices and modules, and/or one or more servers.

In examples, the processor 510 may execute service instructions 522, stored with the memory resources 520, in order to enable the network computing system to implement the network service 152 and operate as the network computer system 150 in examples such as described with FIG. 1A through FIG. 1C.

The computer system 500 may also include additional memory resources (“instruction memory 540”) for storing executable instruction sets (“IGDS instructions 545”) which are embedded with web pages and other web resources, to enable user computing devices to implement functionality such as described with the IGDS 100.

As such, examples described herein are related to the use of the computer system 500 for implementing the techniques described herein. According to an aspect, techniques are performed by the computer system 500 in response to the processor 510 executing one or more sequences of one or more instructions contained in the memory 520. Such instructions may be read into the memory 520 from another machine-readable medium. Execution of the sequences of instructions contained in the memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

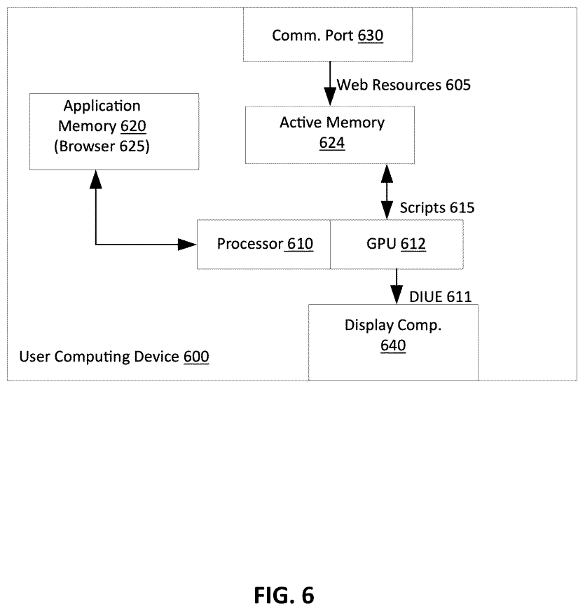

FIG. 6 illustrates a user computing device for use with one or more examples, as described. In examples, a user computing device 600 can correspond to, for example, a workstation, a desktop computer, a laptop or other computer system having graphics processing capabilities that are suitable for enabling renderings of design interfaces and graphic design work. In variations, the user computing device 600 can correspond to a mobile computing device, such as a smartphone, tablet computer, laptop computer, VR or AR headset device, and the like.

In examples, the computing device 600 includes a central or main processor 610, a graphics processing unit (GPU) 612, memory resources 620, and one or more communication ports 630. The computing device 600 can use the main processor 610 and the memory resources 620 to store and launch a browser 625 or other web-based application. A user can operate the browser 625 to access a network site of the network service 152, using the communication port 630, where one or more web pages or other resources 605 for the network service 152 (see FIG. 1A through FIG. 1C) can be downloaded. The web resources 605 can be stored in the active memory 624 (cache).

As described by various examples, the processor 610 can detect and execute scripts and other logic which are embedded in the web resources 605 in order to implement the IGDS 100 (see FIG. 1A through FIG. 1C). In some of the examples, some of the scripts 615 which are embedded with the web resources 605 can include GPU accelerated logic that is executed directly by the GPU 612. The main processor 610 and the GPU can combine to render a design interface under edit (“DIUE 611”) on a display component 640. The rendered design interface can include web content from the browser 625, as well as design interface content and functional elements generated by scripts and other logic embedded with the web resources 605. By including scripts 615 that are directly executable on the GPU 612, the logic embedded with the web resources 605 can better execute the IGDS 100, as described with various examples.

CLAUSE 1. In various embodiments, a network computer system comprises one or more processors; and one or more memory resources storing instructions that, when executed by the one or more processors, cause the one or more processors to perform operations that comprise providing design system instructions to a networked computing device, wherein the design system instructions, when executed at the networked computing device, cause the networked computing device to perform operations comprising: determining that a main component in a design interface includes a freeform content area; rendering, on a canvas, a visual representation of the freeform content area within an instance of the main component; receiving, via an input interface, a first set of user input specifying content to be inserted in the freeform content area of the instance; and populating the freeform content area within the instance with the content.

CLAUSE 2. The network computer system of clause 1 or 2, further comprising: receiving, via the input interface, a second set of user input for converting one or more elements within the main component into the freeform content area; and generating the freeform content area within the main component in response to the second set of user input.

CLAUSE 3. The network computer system of any of clauses 1-2, wherein generating the freeform content area within the main component comprises adding the one or more elements to the freeform content area.

CLAUSE 4. The network computer system of any of clauses 1-3, wherein the second set of user input comprises at least one of a selection within a context menu associated with the one or more elements, a keyboard shortcut, or a selection of a user-interface element.

CLAUSE 5. The network computer system of any of clauses 1-4, wherein the one or more elements comprise one or more layers grouped within a container.

CLAUSE 6. The network computer system of any of clauses 1-5, wherein the first set of user input further specifies a change to the one or more elements.

CLAUSE 7. The network computer system of any of clauses 1-6, further comprising displaying one or more content suggestions for content available for insertion in the freeform content area, wherein the first set of user input includes a selection of a content suggestion from the one or more content suggestions, and wherein populating the instance comprises adding at least a portion of the content associated with the content suggestion to the freeform content area.

CLAUSE 8. The network computer system of any of clauses 1-7, wherein adding the at least a portion of the content to the freeform content area comprises determining one or more dimensions associated with the at least a portion of the content based on one or more size constraints associated with the content suggestion.

CLAUSE 9. The network computer system of any of clauses 1-8, wherein the one or more size constraints comprise at least one of a fixed dimension or a scale factor.

CLAUSE 10. The network computer system of any of clauses 1-9, wherein adding the at least a portion of the content to the freeform content area comprises determining one or more attributes of the at least a portion of the content based on the content suggestion.

CLAUSE 11. The network computer system of any of clauses 1-10, wherein the one or more attributes comprise at least one of an element type, a color, a layout, a textual content, a font attribute, a line attribute, or a shape.

CLAUSE 12. The network computer system of any of clauses 1-11, wherein the operations further comprise: updating the visual representation to include the content within the freeform content area.

CLAUSE 13. The network computer system of any of clauses 1-12, wherein the instance of the main component is linked to the main component, and wherein a change in the main component is propagated to the instance.

CLAUSE 14. A non-transitory computer-readable medium that stores instructions, executable by one or more processors, to cause the one or more processors to perform operations comprising: determining that a main component in a design interface includes a freeform content area; rendering, on a canvas, a visual representation of the freeform content area within an instance of the main component; receiving, via an input interface, a first set of user input specifying content to be inserted in the freeform content area of the instance; and populating the freeform content area within the instance with the content.

CLAUSE 15. The non-transitory computer-readable medium of clause 14, wherein determining that the main component in the design interface includes the freeform content area comprises: receiving, via the input interface, a second set of user input for converting one or more elements within the main component into the freeform content area; and generating the freeform content area within the main component in response to the second set of user input.

CLAUSE 16. The non-transitory computer-readable medium of clause 14 or 15, wherein generating the freeform content area within the main component comprises adding the one or more elements to the freeform content area.

CLAUSE 17. The non-transitory computer-readable medium of any of clauses 14-16, wherein populating the instance comprises modifying the one or more elements within the freeform content area based on the first set of user input.

CLAUSE 18. The non-transitory computer-readable medium of any of clauses 14-17, further comprising displaying one or more content suggestions for content available for insertion in the freeform content area, wherein the first set of user input includes a selection of a content suggestion from the one or more content suggestions, and wherein populating the instance comprises adding at least a portion of the content associated with the content suggestion to the freeform content area.

CLAUSE 19. The non-transitory computer-readable medium of any of clauses 14-18, wherein the instance of the main component is linked to the main component, and wherein a change in the main component is propagated to the instance.

CLAUSE 20. A method for operating a computing device comprising one or more processors, the method comprising: determining that a main component in a design interface includes a freeform content area; rendering, on a canvas, a visual representation of the freeform content area within an instance of the main component; receiving, via an input interface, a first set of user input specifying content to be inserted in the freeform content area of the instance; and populating the freeform content area within the instance with the content.

CLAUSE 21. The method of clause 20, wherein generating the instance comprises adding at least a portion of the content associated with one or more content suggestions to the freeform content area.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computer system comprising:
one or more processors; and
one or more memory resources storing instructions that, when executed by the one or more processors, cause the one or more processors to perform operations that comprise providing design system instructions to a networked computing device, wherein the design system instructions, when executed at the networked computing device, cause the networked computing device to perform operations comprising:
determining that a main component in a design interface includes a freeform content area;
rendering, on a canvas, a visual representation of the freeform content area within an instance of the main component;
receiving, via an input interface, a first set of user input specifying content to be inserted in the freeform content area of the instance; and
populating the freeform content area within the instance with the content.

2. The network computer system of claim 1, further comprising:
receiving, via the input interface, a second set of user input for converting one or more elements within the main component into the freeform content area; and
generating the freeform content area within the main component in response to the second set of user input.

3. The network computer system of claim 2, wherein generating the freeform content area within the main component comprises adding the one or more elements to the freeform content area.

4. The network computer system of claim 2, wherein the second set of user input comprises at least one of a selection within a context menu associated with the one or more elements, a keyboard shortcut, or a selection of a user-interface element.

5. The network computer system of claim 2, wherein the one or more elements comprise one or more layers grouped within a container.

6. The network computer system of claim 2, wherein the first set of user input further specifies a change to the one or more elements.

7. The network computer system of claim 1, further comprising displaying one or more content suggestions for content available for insertion in the freeform content area,
wherein the first set of user input includes a selection of a content suggestion from the one or more content suggestions, and
wherein populating the instance comprises adding at least a portion of the content associated with the content suggestion to the freeform content area.

8. The network computer system of claim 7, wherein adding the at least a portion of the content to the freeform content area comprises determining one or more dimensions associated with the at least a portion of the content based on one or more size constraints associated with the content suggestion.

9. The network computer system of claim 8, wherein the one or more size constraints comprise at least one of a fixed dimension or a scale factor.

10. The network computer system of claim 7, wherein adding the at least a portion of the content to the freeform content area comprises determining one or more attributes of the at least a portion of the content based on the content suggestion.

11. The network computer system of claim 10, wherein the one or more attributes comprise at least one of an element type, a color, a layout, a textual content, a font attribute, a line attribute, or a shape.

12. The network computer system of claim 1, wherein the operations further comprise:
updating the visual representation to include the content within the freeform content area.

13. The network computer system of claim 1, wherein the instance of the main component is linked to the main component, and wherein a change in the main component is propagated to the instance.

14. A non-transitory computer-readable medium that stores instructions, executable by one or more processors, to cause the one or more processors to perform operations comprising:
determining that a main component in a design interface includes a freeform content area;
rendering, on a canvas, a visual representation of the freeform content area within an instance of the main component;
receiving, via an input interface, a first set of user input specifying content to be inserted in the freeform content area of the instance; and
populating the freeform content area within the instance with the content.

15. The non-transitory computer-readable medium of claim 14, wherein determining that the main component in the design interface includes the freeform content area comprises:
receiving, via the input interface, a second set of user input for converting one or more elements within the main component into the freeform content area; and
generating the freeform content area within the main component in response to the second set of user input.

16. The non-transitory computer-readable medium of claim 15, wherein generating the freeform content area within the main component comprises adding the one or more elements to the freeform content area.

17. The non-transitory computer-readable medium of claim 16, wherein populating the instance comprises modifying the one or more elements within the freeform content area based on the first set of user input.

18. The non-transitory computer-readable medium of claim 14, further comprising displaying one or more content suggestions for content available for insertion in the freeform content area,
wherein the first set of user input includes a selection of a content suggestion from the one or more content suggestions, and
wherein populating the instance comprises adding at least a portion of the content associated with the content suggestion to the freeform content area.

19. The non-transitory computer-readable medium of claim 14, wherein the instance of the main component is linked to the main component, and wherein a change in the main component is propagated to the instance.

20. A method for operating a computing device comprising one or more processors, the method comprising:
determining that a main component in a design interface includes a freeform content area;
rendering, on a canvas, a visual representation of the freeform content area within an instance of the main component;
receiving, via an input interface, a first set of user input specifying content to be inserted in the freeform content area of the instance; and
populating the freeform content area within the instance with the content.

21. The method of claim 20, wherein generating the instance comprises adding at least a portion of the content associated with one or more content suggestions to the freeform content area.
